(19) United States
(12) Patent Application Publication
(10) Pub. No.: US 2019/0055841 A1
(43) Pub. Date: Feb. 21, 2019

(54) PRODUCTION AND STIMULATION MONITORING

(71) Applicant: SCHLUMBER TECHNOLOGY CORPORATION, Sugar Land, TX (US)

(72) Inventors: Dominic Joseph Brady, Al-Khobar (SA); Mehdi Ghommem, Al-khobar (SA); Xiangdong Qiu, Al-Khobar (SA); Mustapha Abbad, Al-Khobar (SA)

(21) Appl. No.: 16/102,474

(22) Filed: Aug. 13, 2018

Related U.S. Application Data
(60) Provisional application No. 62/545,822, filed on Aug. 15, 2017.

(51) Int. Cl. E21B 49/00; G01V 3/20

(52) U.S. Cl. CPC E21B 49/008; G01V 3/20

(57) ABSTRACT

A downhole electrode assembly is provided for deployment in a wellbore that traverses a rock formation, wherein the wellbore is filled with a wellbore fluid. The electrode assembly includes an electrode for contacting the rock formation and a pliable structure that is configured during operation to contact the rock formation and provide a fluid barrier that isolates the electrode from the wellbore fluid. The assembly further includes a force member configured to apply a force that presses the assembly against the rock formation.

### CROSS-REFERENCE TO RELATED APPLICATION(S)

The subject disclosure claims priority to U.S. Provisional Appl. No. 62/545,822, entitled “Production and Stimulation Monitoring,” filed on Aug. 15, 2017, commonly assigned to assignee of the subject application and herein incorporated by reference in its entirety.

### BACKGROUND

The subject disclosure relates to measuring electric potential. Furthermore, the subject disclosure relates to downhole voltage electrodes that are installed in a well to monitor production, stimulation, cleaning operations, and other wellbore operations.

A voltage potential is generated when a conductive fluid is forced through a porous medium under pressure and is due to the presence of an electric double-layer adjacent to the pore wall of the medium. This is also called streaming potential and is generated because the flow gives rise to a net transport of charges within the fluid in the pore, which can be detected as a voltage. This voltage, relative to a reference electrode, can be used to infer information about the permeability of porous medium, conductivity of the fluid, and flow through the porous medium. In addition, if the conductivity of fluid is different from the conductivity of fluid in the pore, an additional potential, known as interfacial potential, is generated which combines with other potential sources in the formation such as streaming potential. Similarly, if an ion selective formation, such as a shale layer, is present, another potential, known as membrane potential, is generated and added to the formation potential.

In the oil and gas industry, a wellbore can be drilled into an earth formation, and it is rare to have a perfect pressure balance between the wellbore and formation fluids. During drilling, the wellbore is filled with drilling fluid (wellbore fluid) with a density adjusted to cause a higher wellbore pressure relative to the formation pressure to ensure the formation fluid is trapped in situ and to prevent it from entering the wellbore. The higher pressure in the wellbore causes an invasion process wherein the liquid part of drilling fluid (called filtrate) enters the porous formation. Provided that the filtrate is conductive (such as the filtrate from a water-based drilling fluid), the invasion of formation by the drilling fluid filtrate causes a streaming potential to develop.

Later, when the well is completed and is ready to produce, the fluid pressure scenario is reversed such that the wellbore fluid in the well is kept at lower pressure compared to that in the formation to cause the formation fluid to enter the completed well for production from the well. This can create a streaming potential with an opposite charge. The formation fluid in almost all cases contains conductive water, and as a result, all necessary conditions exist for a streaming potential to be generated.

There have been attempts to measure the streaming potential under downhole conditions by deploying tools equipped with a plurality of electrodes. While the tool is located in the vicinity of a producing formation, i.e. a streaming potential source, the tool measures the potentials, but the measurements are not representative since the tool body interferes with the fluid flow which in turn alters the streaming potential. Further, the measurement is done for a limited time and stops when the tool is retrieved from the well.

In one feasibility study, completion tubing has been equipped with electrodes, so that they remain in situ “permanently”. In this case, the electrodes have been attached to a section of production tubing that is made intentionally non-conductive, as a conductive housing in close proximity to the streaming potential source shorts out the potential and interferes with the measurement. These sections are weak points in the production tubing and although work for a short period of time, in the long run they are not able to cope with the large temperature and pressure variations in the well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a downhole electrode assembly is provided for deployment in a wellbore that traverses a rock formation, wherein the wellbore is filled with a wellbore fluid. The electrode assembly includes an electrode for contacting the rock formation and a pliable structure that is configured during operation to contact the rock formation and provide a fluid barrier that isolates the electrode from the wellbore fluid. The assembly further includes a force member configured to apply a force that presses the assembly against the rock formation.

In an embodiment, the downhole electrode assembly can be used as part of a method of measuring a voltage in a wellbore that traverses a rock formation. The method can involve conveying the downhole electrode assembly to a desired location in the wellbore, activating the force member of the downhole electrode assembly such that the electrode is in contact with the rock formation and the pliable structure provides the fluid barrier that isolates the electrode from the wellbore fluid, and configuring an acquisition unit to perform a voltage measurement using the electrode of the downhole electrode assembly with the electrode in contact with the rock formation.

In another aspect, methods are provided for characterizing a rock formation that is traversed by a wellbore. The methods involve deploying at least one downhole electrode in contact with the rock formation at a desired location in the wellbore, where the at least one downhole electrode is operably coupled to an acquisition unit. A first fluid is injected into the rock formation. The downhole electrode and acquisition unit are used to measure and record a first potential signal in response to flow of the first fluid in the rock formation. A pad of a second fluid is injected into the rock formation, wherein the second fluid is different from the first fluid. The downhole electrode and acquisition unit are used to measure and record a second potential signal in response to flow of the pad of a second fluid in the rock formation. A property of the rock formation can be inferred using the first potential and the second potential.

Other aspects and advantages of the invention will be apparent from the following description and the appended claims.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1A is a cross-sectional schematic view of an example electrode assembly before installation;

FIG. 1B is a schematic top view of the electrode assembly of FIG. 1A;

FIGS. 1C and 1D are cross-sectional schematic views of the example electrode assembly of FIG. 1A during installation on the wellbore wall;

FIG. 2 is a schematic cross-section view of an example electrode assembly attached to a mechanical spring conveyed to a depth of interest;

FIG. 3 is a schematic perspective view of an example activation mechanism designed to release the spring of FIG. 2 as a result of corrosion;

FIG. 4 is a schematic view of an example conveyance tube equipped with multiple electrode assemblies and an acquisition unit before being delivered to downhole location;

FIG. 5 is a schematic view of the example electrode assemblies and acquisition unit of FIG. 4 after being delivered to the downhole location;

FIG. 6 is a block diagram of one embodiment of a downhole acquisition unit;

FIG. 7 is a schematic view of an example laboratory setup used to measure the streaming potential across a rock core plug;

FIGS. 8A and 8B are plots of example experimental results of streaming potential measurements using the laboratory setup of FIG. 7;

FIG. 9A is a plot of an example streaming potential measurement during a production operation, without perturbing the flow;

FIG. 9B is a plot of an example streaming potential measurement during a production operation in which the flow is perturbed by a water flooding operation;

FIG. 10A is a plot of an example streaming potential measurement during a fracture stimulation operation without perturbing the fracturing fluid;

FIG. 10B is a plot of an example streaming potential measurement during a fracture stimulation operation in which the fracturing fluid has been perturbed by injecting a pad of detection fluid; and

FIG. 11 is a plot of an example streaming potential measurement during a matrix acidizing operation where pads of detection fluids are injected during the pre-acidizing and post-acidizing phases.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

Methods are disclosed to measure an electric potential generated in an oil well drilled through an earth formation. An oil-bearing formation is a porous medium and if a conductive fluid enters the formation, or is produced from it, an electro-kinetic potential, in this case streaming potential, is generated which can be measured and used to infer fluid flow and formation properties. In addition to streaming potential, the electric potential may arise from other sources such as spontaneous potential. The spontaneous potential is a sum of interfacial potential that arises when fluids having different conductivities encounter each other, and membrane potential when the two fluids are separated by an ion selective formation, such as a shale layer. Other sources of electric potential such as electroacoustic potential, electro-osmosis potential, and electrophoretic potentials may also contribute to the measured potential.

A voltage measuring electrode suitable for sensing the electric potential of the formation is disclosed which is not affected by the wellbore fluid and can survive for a relatively long time in downhole environments. In addition, an acquisition unit can be provided that controls the data acquisition, stores the data, and communicates the data to uphole locations for further analysis. The system can provide valuable information during the production and stimulation phases of the well life.

Downhole measurement of streaming potential uses a voltage electrode at or close to the location where the voltage is generated. Ideally, one needs to have an electrode on each side of the voltage source. However, the wellbore environment lends itself to having only one electrode attached to the rock formation (i.e., borehole wall). As a result, the second electrode (which is commonly referred to as the “reference electrode”) is usually placed in a location far enough away from the first electrode, where it's potential is not affected by the processes that generate the streaming potential being measured.

Previously used mechanisms to place electrodes in contact with a hydrocarbon bearing formation include U.S. Pat. No. 7,520,324, which is herein incorporated by reference. This uses metal electrodes embedded in one or more insulated centralizer arms. The centralizer arms, attached to production tubing, press the electrodes to the formation wall helping to improve the electrical contact between the electrode and formation face. The design has the disadvantage that the electrode is not isolated from the formation fluid. Further, it requires centralizer arms and a section of production tubing to be electrically insulating. For long term installation, an insulated production tubing will not survive wellbore pressures, temperatures, and fluids. Another approach employs a swellable packer element for placing an electrode in contact with the formation. See US Patent Publication No. 2012/0175135, which is herein incorporated by reference.

This disclosure describes a mechanical arrangement to exert a force to press the electrode to the rock formation (i.e., borehole wall) and isolate the streaming potential electrodes from wellbore fluids, which could interfere with the measurement. Preventing electrode contact with the formation fluid, which can vary as a function of time, circumvents the requirement for the reference electrode to be in contact with the same solution at the same time to avoid parasitic electrochemical potential. It is well known in the art that two electrodes being in contact with solutions having differing ionic concentrations measure a voltage proportional to the ratio of these ionic concentrations. In the current case, the electrodes measure formation potential, and a potential caused by the concentration of wellbore fluid is a parasitic. Pressing the electrode to the rock formation also serves to move the electrodes away from the production tubing, making them responsive to the potential producing events taking place in the formation.

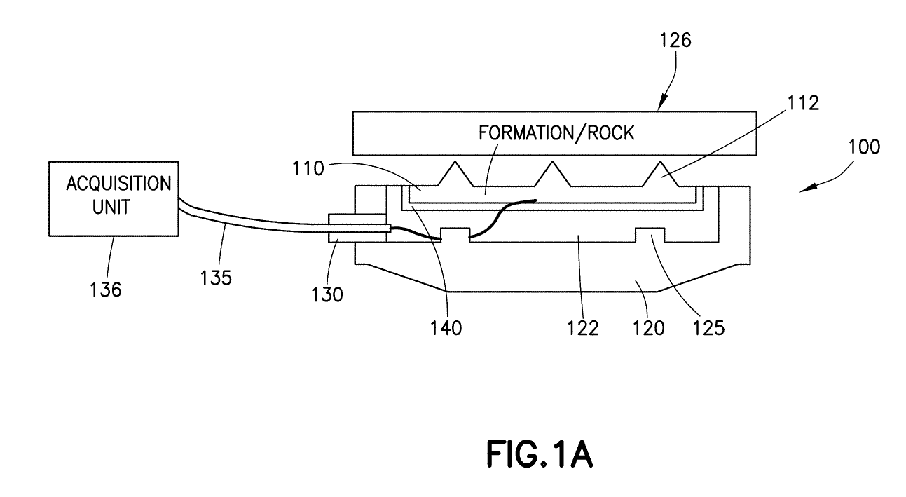

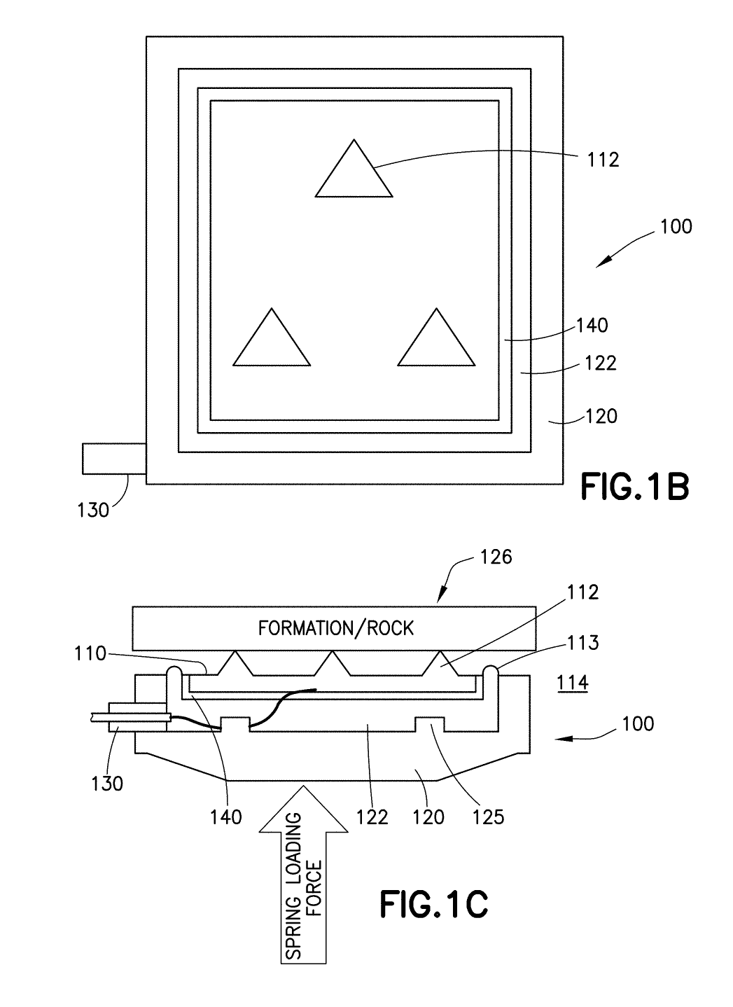

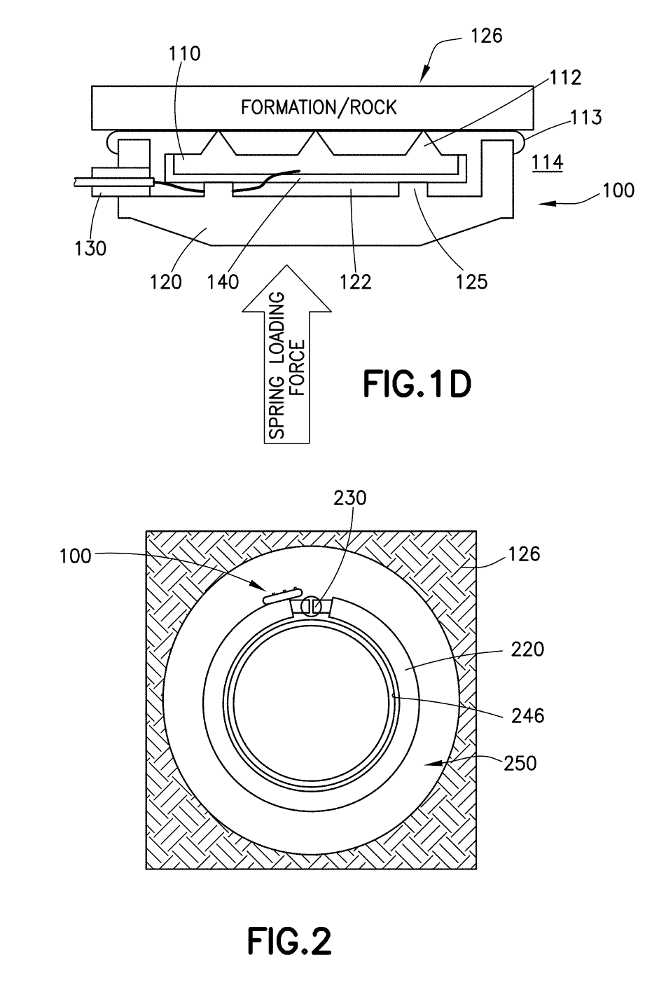

FIG. 1A shows an electrode assembly 100 which contains an electrode 110 formed of, or coated with, a hard and corrosion resistant electrically conductive material. This electrically conductive material can be selected so as the exposure to the wellbore fluids will not alter the sensing surface and quality of the contact between electrode and the rock surface. The material may be a metal such as gold, silver, platinum, lead, nickel or cobalt, and any of their alloys. The electrode material may also be a conductive non-metallic material such as tungsten carbide, vitreous carbon, indium tin oxide, lanthanum-doped strontium titanate, and ytterium-doped strontium titanate.

Referring to FIGS. 1A and 1B, the electrode 110 includes a face that contacts the exposed borehole wall of the rock formation 126. The face may be flat or may be curved to better match the curvature of the borehole wall. The face of the electrode 110 may be formed with raised elements 112, such as spikes or cylindrical extrusions as shown, which are designed to act as stress concentrators and assist in the electrode 110 making a high quality and stable contact with the rock formation 126 by embedding slightly into the surface of the rock formation 126. For example, FIG. 1B shows the face of the electrode 110 with three raised elements 112 that are disposed in a triangular pattern about the center of the electrode 110.

The electrode 110 is electrically connected to a contact terminal 130 by a wire conductor or other conductive path as shown. The contact terminal 130 provides a robust connection (electrically and mechanically) to a cable 135, which provides electrical connection to an acquisition unit 136 as shown. For long term installations, ions from wellbore fluid can diffuse through the polymeric insulation of the cable 135. One preventive action will be to slow this effect by using a diffusion barrier, such as a metal sheet layer between the central wire and the exposed surface of the cable 125. Such a cable 135 may be of a coaxial design. Another action will be to use insulating material that lasts long enough for this effect to happen outside the useful time window of the system. For fracturing operations, the useful time window may be a matter of weeks or months between completion and stimulation, and this approach is feasible. However, for production the useful time window is on the order of decades, which may justify using cables of coaxial design. The wire carrying signal from electrode to acquisition system may have the same galvanic potential. Thus, in one example, this may be accomplished by ensuring the center conductor of coaxial cable 135 extends passed the contact terminal 130 and connects to the electrode 110 directly.

The electrode 110 is fixed to an electrode carrier 120 by an insulating spacer 140 and pliable structure 122. In addition, the assembly 100 holds the electrode 110 and the contact terminal 130 mechanically together. The insulating spacer 140 is disposed between the electrode 110 (and its raised elements 112) and the carrier 120. The insulating spacer 140 can be configured to surround the base of the electrode 110 and function to electrically isolate the electrode 110 (and its raised elements 112) from the carrier 120. The insulating spacer 140 may be made of ceramic, polyether ether ketone (PEEK), or any other suitable material. The pliable structure 122 is also disposed between the electrode 110 (and its raised elements 112) and the carrier 120 and can be configured to surround the base of the electrode 110. In the embodiment shown, the pliable structure 122 is disposed between the insulating spacer 140 and the carrier 120.

When the electrode assembly 100 is deployed in a wellbore, a spring loading force is applied to the carrier 120 that is directed toward the rock formation 126, which in turn forces the electrode 110 (particularly the raised elements 112 when present) to contact the rock formation 126. Under the action of this force, the pliable structure 122 might extrude from the assembly such that part of the pliable structure 122 deforms and extends away from the assembly and toward the rock formation 126. The start of such extrusion is labelled 113 in FIG. 1C. The extrusion of the pliable structure 122 can continue such that the extruded part of the pliable structure 122 forms a fluid barrier or seal that surrounds the electrode 110 between the electrode 110 and formation rock 126, which protects the exposed surface of the electrode 110 from the wellbore fluid 114. In this manner, the extruded fluid barrier ensures that the measurements made by the electrode 110 are as a result of the streaming potential in the rock formation 126 and are not influenced by the wellbore fluid 114.

FIG. 1D shows an example configuration where the extruded part of the pliable structure 122 completely fills the gap space between the electrode 110 and the rock formation 126. In this configuration, the extruded part 113 of the pliable structure 122 forms a fluid barrier or seal between the electrode 110 and formation rock 126 with a perimeter that surrounds the electrode 110 as evident from FIG. 1D. In this manner, the extruded fluid barrier protects the electrode 110 from the wellbore fluid 114 and ensures that the measurements made by the electrode 110 are as a result of the streaming potential in the rock formation 126 and are not influenced by the wellbore fluid 114.

In embodiments, the pliable structure 122 can be formed from a suitable elastomeric polymeric material such that deformation and resulting extrusion of the pliable structure 122 is reversible. In this manner, when the spring loading force is removed, the pliable structure 122 can return to its normal shape (FIG. 1A). In alternative embodiments, the pliable structure 122 can be formed from a polymeric material such that deformation and resulting extrusion of the pliable structure 122 is irreversible or permanent. In this manner, when the spring loading force is removed, the pliable structure 122 will not return to its normal shape prior to the application of the spring loading force in the wellbore (FIG. 1A).

In embodiments, the carrier 120 and the pliable structure 122 can also include one or more standoff features 125 on the surfaces opposite the electrode 110 as shown in FIGS. 1A, 1C and 1D. Such standoff feature(s) 125 can be configured to control or limit the extrusion of the pliable structure 122 and prevent crushing of wires. Such standoff feature(s) 125 can also be configured to limit the pitch/yaw of the electrode 110 relative to the carrier 120.

The electrode assembly 100 can be deployed and installed on the rock formation during or after the drilling operation. In accordance with the current disclosure, the drill pipe, casing string, coil tubing, or production tubing can be used as the deployment tube to carry the electrode assembly to the depth of interest. The electrode assembly 100 can be attached to the outside wall of the deployment tube and delivered to the depth of interest where a release mechanism is activated to attach the assembly to the rock formation.

FIG. 2 shows an example in which an electrode assembly 100 is attached to a torsion spring 220. The spring 220 is held in a compressed state at its two ends by an activation mechanism 230 on the outside wall of a conveyance tube located in a well 250 drilled in a formation 126. The activation mechanism 230 can be configured to release the spring 220, allowing it to expand and conform to the rock formation 126. The activation mechanism can possibly use at least one of the three possible modes of operation as described below. With the electrode assembly 100 attached to the outer face of the spring 220, as shown in the example of FIG. 2, the expansion of spring 220 can apply spring loading force to the carrier 120 of the assembly 100 that brings the electrode 110 in contact with the rock formation, and the remaining expansion of the spring 220 can press the electrode 110 into the rock formation 126 and cause extrusion of the pliable structure 122. For a known wellbore diameter, the dimensions and stiffness of the spring 220 may be chosen such that desired force is applied to the electrode assembly 100 after the spring 220 is released.

In some embodiments, the spring 220 may be covered with an insulating material to prevent electrical interference with the potential being measured. In an implementation similar to that of FIG. 2, multiple electrode assemblies can be attached to the spring 220 and can be positioned around the perimeter of the spring 220. Multiple electrodes, if present, can provide additional directional information on the fluid movement. Alternately, the measurements from multiple electrodes can be averaged to reduce electrode bias and drift. In cases where the wellbore is not smooth enough, a swivel mechanism can be used to attach the electrode assembly 100 to spring 220 which helps the electrode face to better conform to rock formation 126.

There are at least three modes of operation for the activation system:

Active surface control mode: uses a hydraulic system controlled by pressure from the surface to release each spring at a determined time. This mode provides an effective control over the time of activation. This mode could also be designed to close the spring again for more of an intervention operation in addition to permanent deployment approach. The system could, for example, be deployed on coiled tubing if it is desired to retrieve the electrode assemblies. Hydraulic system design for retrieving or fishing operations are well known in the art of completing a well.

Passive hydraulic control mode: also uses a hydraulic system, but the application of wellbore pressure releases each spring using a frangible element.

Corrosion activated mode: uses a degradable element to release the activation system, typically formed of an alloy or plastic part that holds a mechanism in place, restraining the mechanical spring to ensure the electrode remains inside the footprint of the protection sub while being deployed. This material corrodes on exposure to the completion fluid until its mechanical properties are sufficiently compromised that the mechanism holding the spring releases. This can be implemented by having the spring directly restrained with frangible material; given the desired anchoring/contact forces and therefore the main-spring design, this approach may need a higher strength material such as an aluminum alloy to restrain the spring. Alternatively, especially where multiple-wound torsion springs are employed, the entire spring may be embedded into a degradable plastic, such that the entire length of the coil is restrained, not just the ends. This would also have the advantage of ensuring a “slow” action whereby the spring is gradually released, rather than a system that snaps the spring causing a sudden contact between the electrode and rock formation.

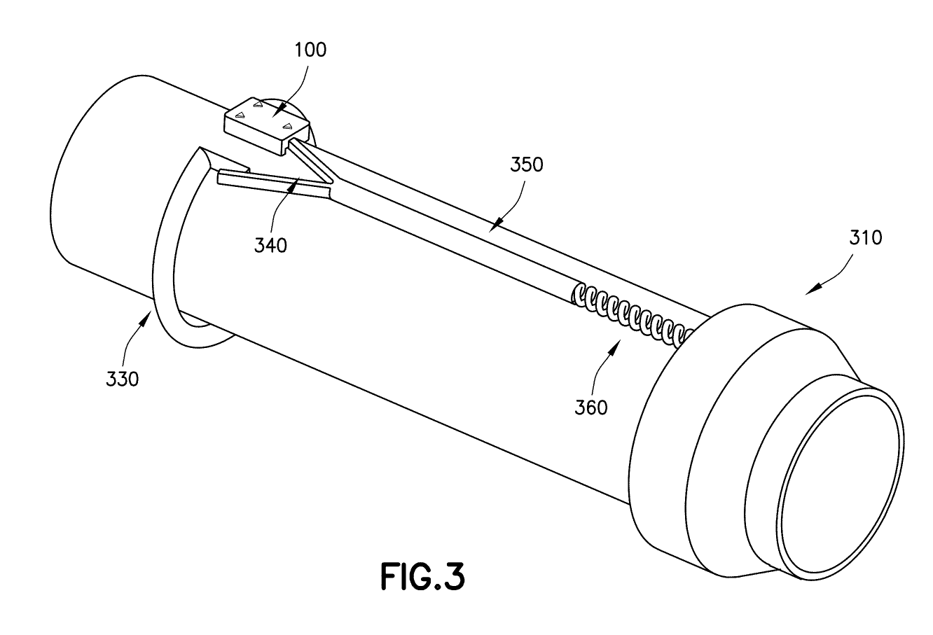

FIG. 3 shows an embodiment of a release mechanism. A deployment tube 310 is used to carry the electrode assembly 100 to a downhole location. The electrode assembly 100 is attached to a compression spring 330, which is maintained in a compressed state by tapered edges 340 of a restraining piston 350 and is held in place by a frangible element 360 that prevents the restraining piston 350 from disengaging the spring 330. At a time after the assembly is delivered to the desired depth, the frangible element 360 corrodes and releases a force on the restraining piston 350 allowing the piston to move under the action of either a second spring, or the restrained compression spring 330, releasing the spring 330. This system employs the mechanical advantage of the tapered edge 340 to ensure the restraining force is released in a controlled manner avoiding an instantaneous release of the spring 330. If the activation system releases the spring 330 in a controlled and low-impact manner, it may prevent damage to the electrode and associated contacts. This could be achieved by suitable design of the taper 340.

In the example of FIG. 2, the material used to restrain the mechanical spring 220 corrodes and releases the spring. In some embodiments, the restraining material and corrodible material can be the same. In the embodiment of FIG. 3, the restraining material used to make the tapered edges 340 is different from the frangible material 360 used to corrode and release the spring 330. This allows designing the restraining and releasing functions independently, allowing each to be optimized to factors such as different spring designs, wellbore temperatures, and wellbore fluids.

After or while drilling, the formation can be logged and the layer of interest from which fluid is to be extracted is identified. The logs will provide the depth and thickness of the layer of interest which can be used to plan the locations where the electrodes will be deployed. This information is used to assemble the necessary components uphole before delivering to a downhole location.

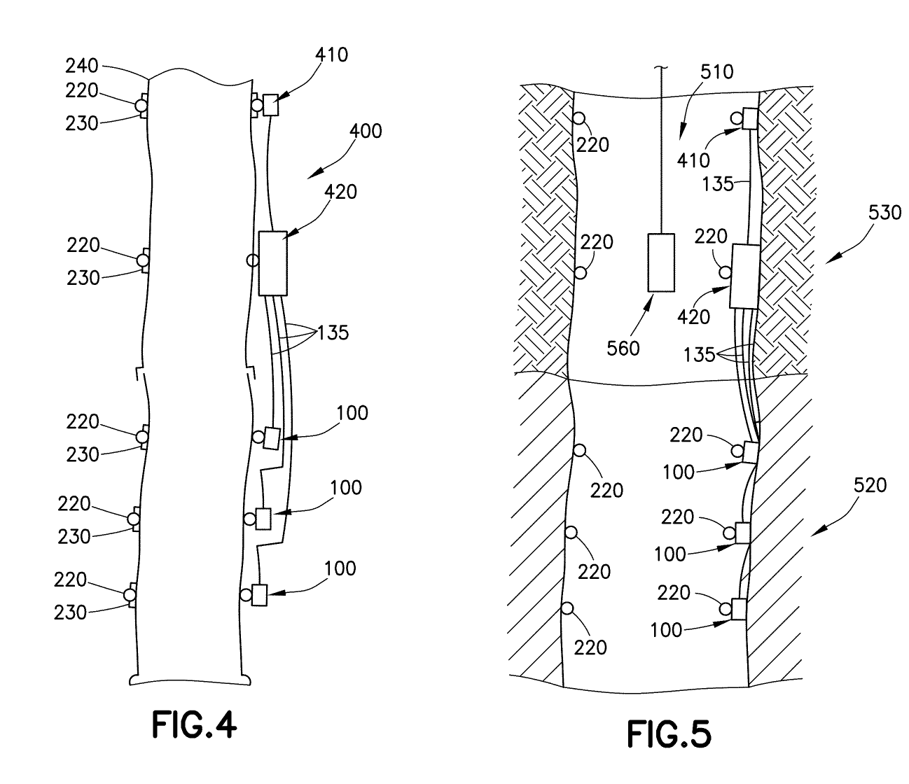

FIG. 4 shows a system 400 of electrode assemblies 100 and measurement electronics assembled at an uphole location. A conveyance tube 240 is equipped with the electrode assemblies 100 at selected inter-electrode distances. The electrode assemblies 100 and the corresponding compression springs 220 are attached to appropriate activation mechanisms 230 before deployment. Also provided is a reference electrode 410 to be attached to a different, impermeable, formation layer at some distance above or below the layer of interest. The reference electrode 410 can have the same design or some other suitable design as the electrode assembly 100.

In some embodiments, the reference electrode 410 and the one or more measuring electrode assemblies 100 can be in different wells. As an example, for production monitoring, there may be a production well, an injection well, and a monitoring well. One or more measurement electrode assemblies 100 and the reference electrode 410 can be within one of these wells. In other embodiments, the one or more measurement electrode assemblies 100 may be located in one well, for example in a production well, while the reference electrode 410 may be in any of the other wells, for example injection or monitoring well.

Additionally, an acquisition unit 420 is provided to perform and control the potential measuring operation. In FIG. 4, three measuring electrode assemblies 100 are shown, however, the number of measuring electrode assemblies can vary depending on the heterogeneity of earth layer and the detail level of information desired. FIG. 4 also shows the cables 135 that connect the measuring electrode assemblies 100 to the acquisition unit 420 as well as a cable that connects the reference electrode 410 to the acquisition unit 420. The acquisition unit 420 may be attached on the conveyance tube 240. In situations where the conveyance tube 240 is removed after delivering the electrodes, such as coil tubing or drill pipes, the acquisition unit 420 may be secured to the rock formation 126 (i.e., the borehole wall). In other situations where casing or production tubing is used, the acquisition unit 420 may remain attached to the conveyance tube 240.

FIG. 5 shows the system 400 of electrodes and acquisition unit of FIG. 4 installed in a downhole location where the system of FIG. 4, has been assembled and then conveyed to the desired depth in a well 510 drilled into the earth formation including a hydrocarbon bearing formation 520 and an impermeable formation 530. At the desired depth, the activation mechanisms have been used to contact the measuring electrode assemblies 110 to the hydrocarbon bearing formation 520 and contact the reference electrode 410 to the impermeable formation 530. In the example of FIG. 5, the conveyance tube 240 has been removed from the well after the installation. In other examples, not shown, the conveyance mechanism can remain in the well and perform its own function.

The acquisition unit 420 collects and stores voltage data that represent the voltage differences between respective electrodes 110 of the measuring electrode assemblies 110 and the reference electrode 410 as a function of time. The acquisition unit 420 can be designed to perform different functions integrated into a pressure and environmentally resistant container.

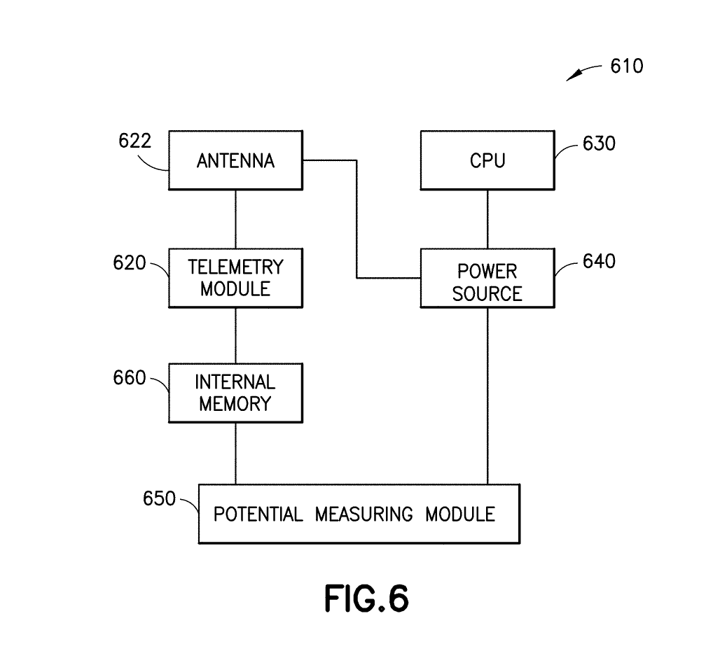

FIG. 6 shows an exemplary acquisition unit 610 including at least one telemetry module 620, an antenna 622, a central processing unit 630, a power source 640, a potential measuring module 650, and multiple pressure feedthroughs (not shown). The feedthroughs provide an electrical connection between the acquisition unit and the electrode assemblies. The central processing unit 630 may be programmed to compare the incoming signals against an internal precision voltage reference to minimize any drift in the electronics before measuring the received voltages. Data is recorded in the internal memory 660.

The acquisition unit 420 can be configured for several different telemetry systems to deliver the recorded data. When the system is configured with a control line between acquisition unit and the surface, the telemetry can be real-time and occur over an electrical or optical conduit. Two of the possible telemetry options are described next, and they may employ standard or purpose designed logging tools that are deployed within the well to facilitate communication with the acquisition unit.

Referring to FIG. 5, a receiving tool 560 is delivered to the vicinity of acquisition unit 420 and is used to receive the acquired data from one or multiple acquisition units 420. The receiving tool 560 can operate using direct or passive transmission modes.

Direct transmission telemetry: a receiving tool 560 announces its presence in the wellbore with a transmit signal which can be received by the acquisition unit 610 through the antenna 622. This can be used to trigger communication between the acquisition unit 610 and the receiving tool 560. Acoustic, radio frequency (RF), or X-ray can be used to initiate and perform communication. Acoustic offers the advantage that it can more easily pass through the production or casing string, whereas RF is more easily configured for ultra-low power systems, and pulsed x-ray has substantially greater penetration power at a cost of high power consumption. Once the communication is established, the recorded data can be transmitted to the receiving tool 560, and the acquisition programming of the acquisition unit 420 can be revised, if needed. One such revision, may change the sampling rate (time between measurements) depending on the life of the well and the operation that is performed at the time.

Passive transmission telemetry: This mode of data transmission uses lower power than a direct transmission system. In this mode the RF transmit pulse from the receiving tool 560 is modulated by the acquisition unit 610 and reflected back. The acquisition unit 610 may employ a resonator that may be tuned by its own electronics to match the emitted signal from a receiving tool 560. Alternately, the receiving tool 560 searches for the optimum frequency of the resonator in the telemetry module 620 of acquisition unit 610. Once the optimum frequency is found, it can be used for actual communication. This approach places the burden of tuning the frequency on the receiving tool 650 which has much less power and space limitations than the acquisition unit 610.

The potential measurements by the potential measuring module 650, e.g. voltmeter, may be made in a variety of modes:
a. High speed continuous: This mode would typically be employed to capture data during a fracture stimulation treatment, where the operation will be relatively quick and capturing transients is of paramount importance over battery life or memory space.
b. Medium speed continuous: This mode may reflect a more conservative approach to preserve battery life and memory space for something like an acid stimulation, or near-wellbore cleanup treatments.
c. Low speed continuous: This mode may reflect an even more conservative approach to preserve battery usage while still capturing production decline.
d. Sparse sampling: This mode would put the unit into the most conservative battery and memory usage profile for extended production monitoring. This would most likely place the system into a sleep mode, periodically waking up the electronics, allowing them to warm up, and then acquiring data, before placing them back into sleep mode.

Control of the operating mode may be configured to be manual or driven on command from an intervention tool or a pre-defined series of pressure transients driven from the surface. The system may also be configured to switch modes automatically based on a series of pre-set sensor conditions. For example:
a. A switch to a high-speed mode of operation might be triggered by a rapid or significant pressure increase, indicating the onset of a fracturing operation, for example.
b. A switch to medium speed might be configured from an on-board pH sensor, or a lower rate of pressure increase (or decrease) which still exceeds a given threshold, indicating that an acid treatment, or cleanup had started.
c. Low speed and sparse modes may be triggered by a given decline profile in pressure, indicating a production monitoring phase. While in this mode, the frequency with which data is acquired may be reduced. Alternately, the bit-depth or averaging within the data may increase.

The electric power of the power source 640 that drives the electronics of the acquisition unit 610 may come from several different sources described below:
a. Where a physical electrical connection is employed, the electrical power can be supplied down the line.
b. Where these units are “stand-alone” the power can be obtained from an internal battery e.g. lithium cell(s) specifically designed for low-power operation at elevated operating temperature.
c. The power of the internal cell may be augmented by a number of energy-harvesting techniques to extract energy from the nearby movement of fluids, for example, by using a spinner, turbine or vibration energy harvesting system.

In an embodiment, the acquisition of all channels (or signals from the measurement electrodes 110) in the same well are stamped to the same time-base, such that the effect of random clock-walk can be mitigated. This can be achieved in a number of ways, some of which are described below:
a. Where multiple acquisition systems are connected on the same physical line then the clock and acquisition synchronization can be obtained from the telemetry or power bus.
b. The internal clock itself may be designed to ensure stability over time. However, this may place constraints on the design of electronics and associated power consumption.
c. Where no electrical connection is made between units, and the internal clock alone cannot ensure synchronization over the lifetime of the unit, then periodic synchronization can be achieved with the emission of an acoustic signal from the “master” unit, which may be positioned in the middle of the clusters.
d. The systems and data can also be synchronized by the imposition of a periodic or coded flow rate (pressure modulation) on the production of the wellbore which can be detected simultaneously on every sensor channel, or with a well characterized slew between channels. This could take the form of varying the choke on the well, lateral or sub-compartment level, and either detected with dedicated sensors on the system, or using the modulation imposed on the fluid production and hence the measured potential itself.
e. An internal clock of the acquisition unit can be used to maintain acquisition timing accuracy between periodic resets.

In an embodiment, methods are described to monitor streaming potential which in turn provides information about the properties of the flowing fluid affecting the measured formation potential, which include fluid conductivity and viscosity. In addition, the streaming potential can provide information about the formation itself. Insights about the formation are usually brought about by some perturbations in the fluid or rate of flow. Some of these perturbations are relatively short term, such as what is done in stimulation operation. Some are longer term such as the pressure drop caused by production operation. The methods can utilize the downhole electrode assemblies and systems as described herein, or possibly some other downhole electrodes and systems, to measure and record the streaming potential measurements of the reservoir rock traversed by a well. We now discuss examples of these perturbations and how they affect different operations on the well.

### Production Monitoring

The disclosed potential measurement technique can be used to detect and track downhole fluid flow paths along the depth interval of a reservoir. For instance, previous studies based on laboratory measurements and numerical modeling demonstrated the reliability of streaming potential measurements to monitor the evolution of an oil-water encroachment front over time during hydrocarbon recovery. Embodiments of the current disclosure can be adopted in the oilfield by placing a set of downhole electrodes in the wellbore to passively detect the changes in the electric potential, over a relatively long period of time, while producing reservoir fluids. This would offer quasi real-time information that may help reduce uncertainty in the reservoir dynamics and description, which contribute to reservoir management decisions.

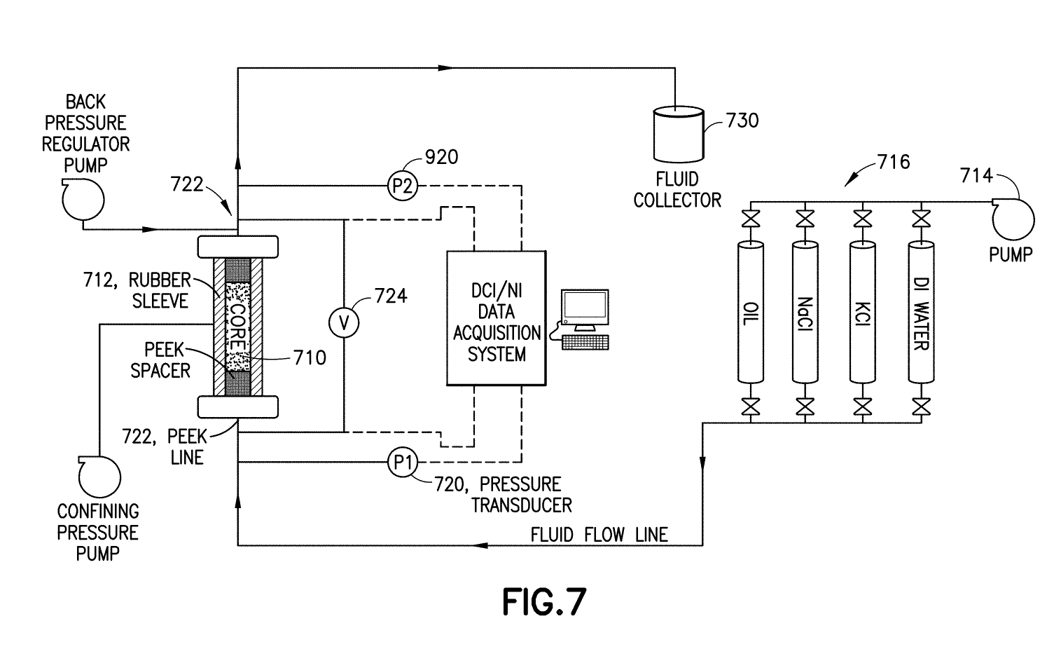

To illustrate the feasibility of using streaming potential to monitor production operations, a series of core flow tests were conducted on oil-saturated carbonate rock cores while measuring the streaming potential. The experimental set-up is shown schematically in FIG. 7. The experiments were conducted on cylindrical (1.5″-diameter by 12″-length) carbonate core 710 samples, which were tightly confined within a core holder using a rubber sleeve 712. To prevent brine leaking through the external surface of the sample, the rubber sleeve 712 was inflated with a confining pressure. The confining pressure was kept at least 1000 psi above the maximum injection pressure used in these experiments. A pump 714 was used to flow oil and then brine through the sample from the accumulators 716, and the resulting pressure difference across the sample length was monitored using a pair of pressure transducers 720.

The streaming potential induced across the sample from the fluid flow was measured using two copper wire electrodes (not shown) which were connected to the PEEK fluid lines 722 in the vicinity of the core inlet and outlet faces. The fluid passed through the sample until the streaming potential and pressure reached stable values. The electrical potential across the core sample was recorded by a digital multi-meter 724 connected to a computer. During the course of experiments effluent sample collector 730 was used to collect samples at the core holder outlet.

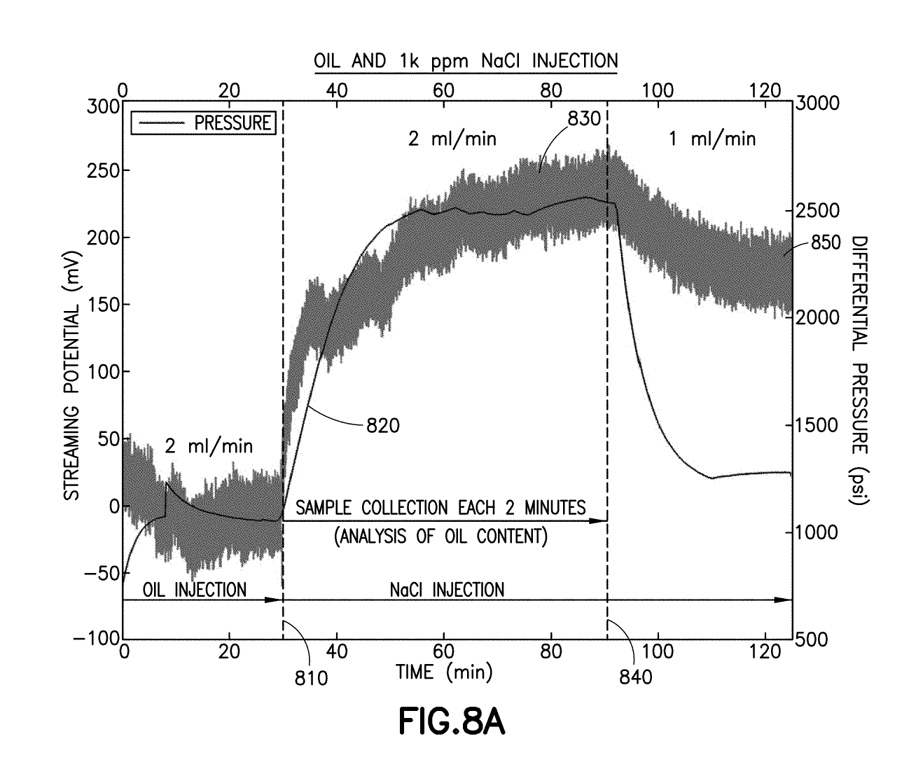

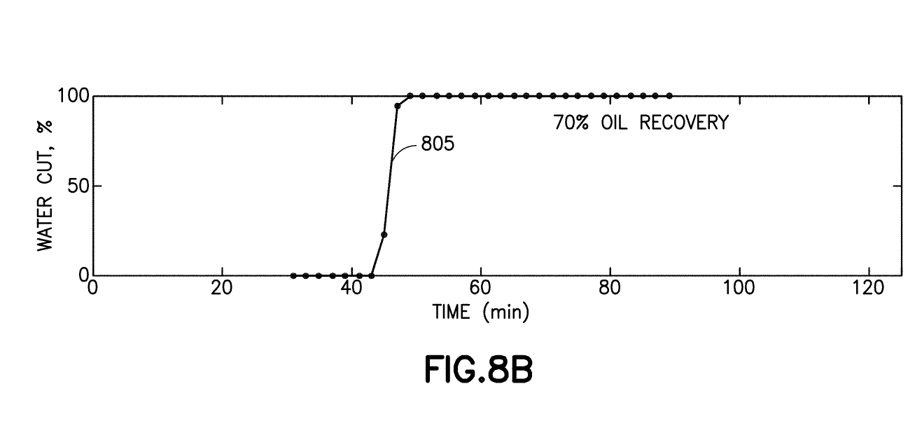

The voltage readings from the digital voltmeter were recorded while injecting oil first and then a brine containing 1000 ppm sodium chloride into the limestone core sample saturated with oil. FIG. 8A shows example data recorded from the experiment. The measured differential pressure and voltage across the core length are plotted in FIG. 8A. During the course of the experiment, effluent samples were collected every 2 minutes for one hour (total 30 samples) from the core holder outlet to track the composition of effluent, measure oil recovery, and correlate the variations in the oil content of the samples with the pressure and streaming potential responses.

Referring now to FIG. 8A, upon switching from injecting oil to injecting brine (e.g., NaCl solution) at time 810, a sharp voltage increase 820 is observed quickly after the brine injection, which later stabilized to a steady value 830. Streaming potential responded well to the variations in the injection rate decreasing from level 830 to level 850 as can be observed when reducing the brine injection rate from 2 ml/min to 1 ml/min at time 840.

FIG. 8B shows the evolution of water cut during the experiment. We observed a sudden and sharp switch 805 from 100% oil to 100% brine.

The obtained trends in the streaming potential demonstrate it is viable to use this type of measurements under downhole conditions to detect and track the water front when having the capability to collect data from a dense grid of electrodes. In one embodiment, one may deploy the downhole streaming potential measurements from an array of electrodes to study the production operation. In this case, the wellbore would be filled with fluid produced from the formation and there would be an expected steady streaming potential intensity (or magnitude) measured by the grid of electrodes (with a slight, long term, reduction in such measurements) as the formation pressure gradually decreases due to production. The response of electrodes at different depths can be compared and any disparity can be attributed to reservoir heterogeneity.

In addition, as production goes on with time, there may be a change in the composition of the produced fluid. The produced fluid is usually a mixture of oil and water phase in the early stage of production, but with time the ratio of water and oil may change and at lower pressures some of the gas dissolved in the oil may appear as the third phase. The streaming potential measurements of the grid of electrodes may be used to infer this fluid composition change in the absence of any other perturbations. Specifically, modeling programs describing the dependence of streaming potential as a function of oil and water contents can be used to infer the time variations of the relative phases.

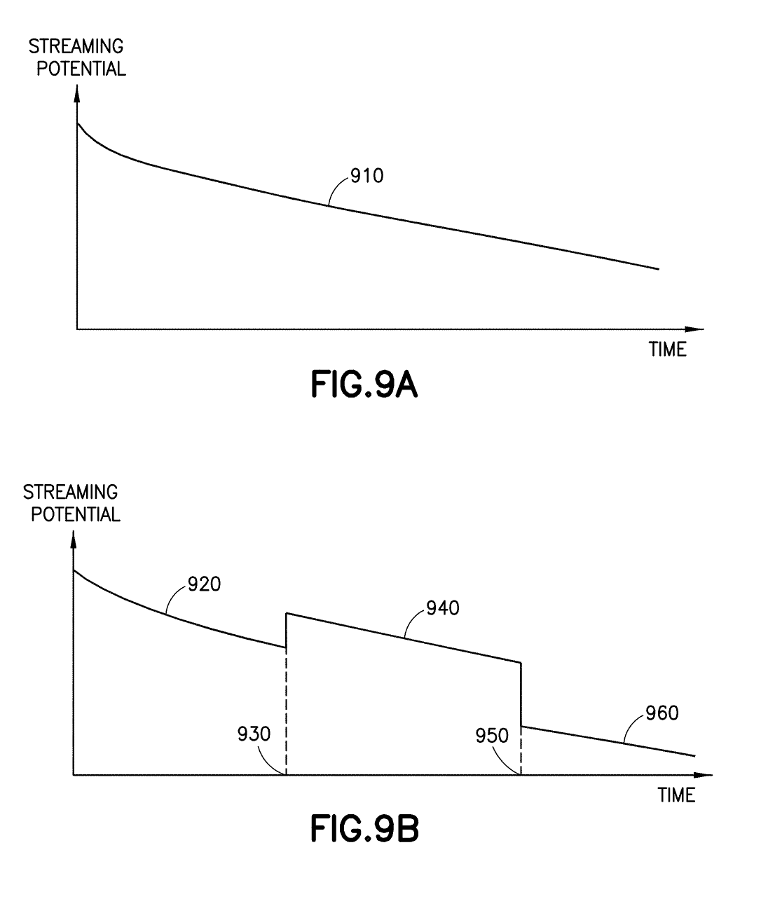

In the production phase, streaming potential measurements made by a grid of electrodes can be perturbed by water flooding, enhanced oil recovery, or gas lift. The water flooding is described here as an example. FIG. 9A shows variation of the measured streaming potential as a function of time during production. The streaming potential profile 910 as a function of time shows an uneventful steady decrease with time. The decrease is caused by a steady reduction of reservoir pressure as more fluid leaves the reservoir. In FIG. 9B the same case for production is depicted as the initial trace 920. At some later time 930, the water flooding operation starts. Water at pressures higher than the reservoir pressure is injected into the formation in an injection well. The short-term effect of water injection is an increase in the formation pressure which leads to an increase in fluid flow into the production well where the grid of electrodes is located. This causes the electrodes to measure higher streaming potential as demonstrated by a new trace 940. The trace 940 changes with time depending how the pressure at injection well is maintained. At a time 950, the flood front reaches the production well (water break through), and the streaming potential decreases to the level of trace 960. In this example, the flooding water generated less streaming potential compared with the formation water. Alternately, if the flooding water generates higher streaming potentials, the trace 960 may move above the level of trace 940. The information in traces 910, 920, 940, and 960 can be interpreted or inverted to gain valuable insight into the water flooding operation and the reservoir properties.

Different parts of the reservoir usually respond differently to the amplitude of pressure wave and to the timing of water break through. The equivalent FIG. 9B for different electrodes, sensitive to different parts of the same reservoir layer, may be different. These differences are due to the inherent complexity of downhole reservoirs such as differing flow paths and local permeability, or perhaps the reservoir is divided into multiple compartments. Having an array of electrodes enables measuring these time and amplitude variations which may be used to infer valuable information about the reservoir and the differing flow paths through the reservoir. This information, in turn, provides valuable input to the reservoir description model, which inherently needs to be described by a large number of data variables for a large reservoir. In this manner, the additional data can greatly enhance the quality of a reservoir description model.

### Stimulation Sensing

The streaming potential signal intensity measured by an electrode in contact with the reservoir rock depends on the conductivity of the fluid that flows through the reservoir rock. Zero fluid conductivity has no measurable signal. Similarly, with extremely high fluid conductivity, rapid recombination of charge in the fluid reduces the streaming potential signal intensity. Hence one application for this disclosure relates to well stimulation operations that inject fluid into reservoir rock, where the composition and electric conductivity of the injected fluid can be controlled.

Well-stimulation operations typically do not use in-well monitoring means during treatment. This disclosure achieves real time stimulation monitoring in two ways. Firstly, by providing information on the stimulation treatment; providing detailed information on the fluid movement within the formation, and how effective a deployed diversion system was during stimulation. Secondly, the disclosure provides information allowing direct comparison between the pre-treatment flow with the clean-up and reverse flows.

Embodiments of the disclosure are applicable to both fracture stimulation and chemical stimulation, and the basic workflow is the same for both, and may include the following stages: pre-treatment, treatment, and post-treatment.

Pre-treatment injection: In this stage, a pad of fluid specifically designed for detection by one or more of the streaming potential electrodes, which is referred to as detection fluid, is injected into the formation. In conjunction with the injection of the detection fluid, the streaming potential signal response is measured by the one or more electrodes and recorded. The detection fluid is designed to have a conductivity or viscosity or both that is different from previously used fluids, and these parameters are optimized to have high signal level and improved detectability. Thus, the streaming potential level that is measured in response to the detection fluid is readily distinguishable from the streaming potential level that is measured in response to the previous fluid.

Stimulation monitoring: In this stage the stimulation fluid, which is designed for optimum fluid/rock interaction, is injected into the formation. In conjunction with the injection of the stimulation fluid, the streaming potential signal response is measured by the one or more electrodes and recorded. The injection of the stimulation fluid may be spaced or interleaved with the injection of pads of detection fluid to sporadically provide higher streaming potential readings and provide data for the evolution of the stimulation treatment course.

Post-stimulation characterization: In this stage, another pad of detection fluid is injected, and the streaming potential is measured by one or more of the streaming potential electrodes. In conjunction with the injection of the detection fluid, the streaming potential signal response is measured by the one or more electrodes and recorded. These post-stimulation streaming potential measurements can be compared to the streaming potential measurements obtained before the stimulation (pre-treatment phase). This is to characterize any improvements resulting from the wellbore stimulation treatment.

Diversion characterization: This includes addition of a diversion system incorporated within a pad of detection fluid such that the impact of the diversion system can be accurately recorded.

Additional stages are also possible where the stimulation treatment employs different diversion fluids to modify/enhance the wellbore coverage of the stimulation. It should be noted that there may be spacer pads between the stimulation and detection/diversion fluid injection periods to limit mixing and to maintain cohesion of the delivered fluids.

### Stimulation Sensing: Fracture Stimulation

Fracture stimulation includes pumping a large volume of fluid into a wellbore causing the pressure to build up to the point that it exceeds the fracture gradient of the formation. A fracture is initiated at a weak point in the formation, followed by hydraulic fracture propagation from the fluid entry point. A variety of fluids can be employed, from the “slickwater” treatments popular in the US shale industry, to cross-linked fluids more common in Saudi Arabia, each with different viscosity profiles vs temperature, pressure, and differing ability to transport proppant into the fracture to prevent fracture closure. Injection and flow-back through the proppant pack are two stages where the streaming potential can be used to obtain valuable information.

Downhole electrodes can be employed to measure streaming potential of the reservoir rock as the fracture is initiating and propagating. The above-mentioned fracturing fluids are typically optimized for their mechanical impact on the rock formation and may not be the best fluid choices for generating formation potential. The slickwater, for example, commonly used as fracturing fluids for unconventional reservoirs, has a total dissolved solid of about 30,000 ppm. It is a very conductive fluid, and therefore may present issues with generating a streaming potential. This may require using a pad of detection fluid to be injected to elevate the streaming potential measurements. For conventional formations, fracturing fluids commonly use fresh water and add clay control agent, friction reducer, gelling agent, cross linkers, breakers, buffers, mutual solvent, and biocides. Among these, clay control agent, breakers, buffers and biocides are generally electrolytes and ionize once they mix with water. So, the conventional fracturing fluids are also conductive to some extent and adding a pad of detection fluid with optimum electrical conductivity, helps generate a larger streaming potential signal.

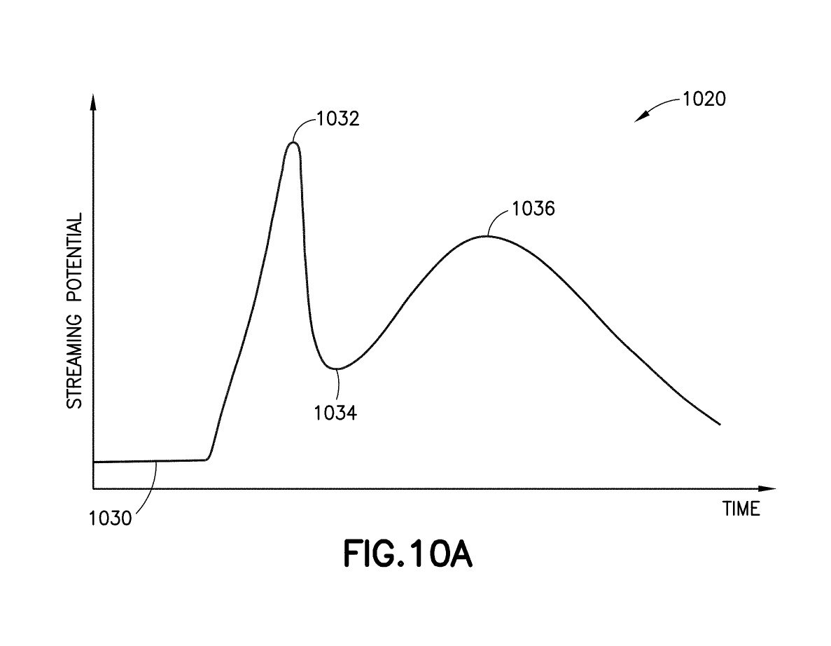

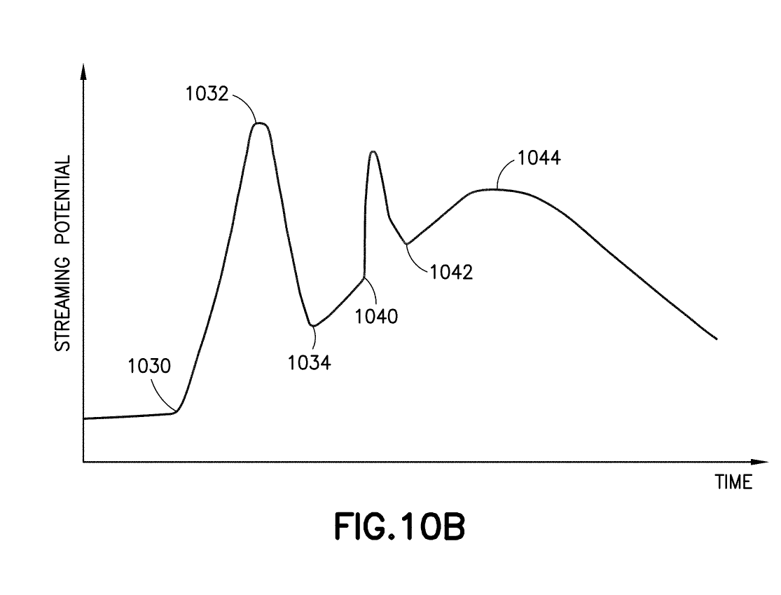

FIG. 10A is based on the modeling result described in U.S. Pat. No. 7,520,324, which is incorporated herein by reference. Trace 1020 is the streaming potential as a function of time, where the potential measuring electrode is deployed in the vicinity of a weak point in the formation where a fracture is expected to initiate. At 1030 a large volume of fracturing fluid is rapidly pumped into the well, causing the pressure to increase sharply and reach a level 1032 that can cause the formation to yield. Once the fracture initiates, it provides a location for fracturing fluid to enter and propagate the fracture. Thus, the pressure ceases to increase passed point 1032. The streaming potential is directly proportional to the pressure and the peak 1032 corresponds to the streaming potential at fracture initiation.

When the formation yields and a fracture initiates, a substantial volume of fracturing fluid rushes into the fracture space, causing the pressure to drop. In parallel, the streaming potential drops from 1032 to 1034. Since the formation has very low permeability, the pressure rises again to a peak level 1036 before the induced fractures dissipates the pressure and lowers the streaming potential.

The response of FIG. 10A is expected from a normal mode of fracturing, and a study of the streaming potential response provides valuable insight on how the local pressure varies with time. The value of this information is augmented even more when the response from an array of electrodes is considered.

FIG. 10B is a response similar to that in FIG. 10A, except at one point, the fracturing fluid is perturbed by injecting a pad of detection fluid into the fracturing fluid; the pad reaches the fracture opening at 1040. The conductivity, viscosity, or both, of the detection fluid can be adjusted to increase the streaming potential. While the detection fluid is still close to the electrode, it measurably affects the streaming potential response, leading to a spike 1040-1042. As expected, the spike gradually decreases when the detection fluid moves away from the electrode and into the formation. However, the added pad affects all streaming potential measured past 1040. For example, the peak 1044 in FIG. 10B is expected to be higher than the peak 1036 in FIG. 10A.

The spike 1040-1042 is added information gained by introducing a different fluid into the fracturing fluid and is an example of how the streaming potential measurements can be perturbed to gain more insight into the fracturing operation. Further, interlacing a pad of a detection fluid can be applied multiple times during the operation to gain extra insight about the formation properties. In some embodiments, multiple pads of the detection fluid are used, and the conductivity, viscosity, composition, or pressure of the detection fluid are varied to increase the information content of the data.

The measurements described above can be performed by one or more downhole electrodes and recorded for analysis and interpretation. Considering the large volume of fluid needed to build the pressure in the well, a standard logging tool with built in potential measuring electrodes may not be a practical choice since the logging tool will restrict the flow of fracturing fluid. In contrast, since some embodiments of electrodes described are small and attach to the borehole wall, they have minimal effect on the flow of fracturing fluid, enabling the fracturing operation to be monitored. Further, the potential measuring electrodes described are not in contact with the wellbore fluid. As a result, the effect of detection fluid pads is only manifested once they are in the formation and not when they are in the borehole.

### Stimulation Sensing: Acid Stimulation

Acid stimulation treatments, such as a matrix acidizing operation, employ extremely conductive acid solutions that would reduce the streaming potential response. However, pre-injection, intra-stimulation, post injection, and diversion pads help make the streaming potential measurable and provide valuable information.

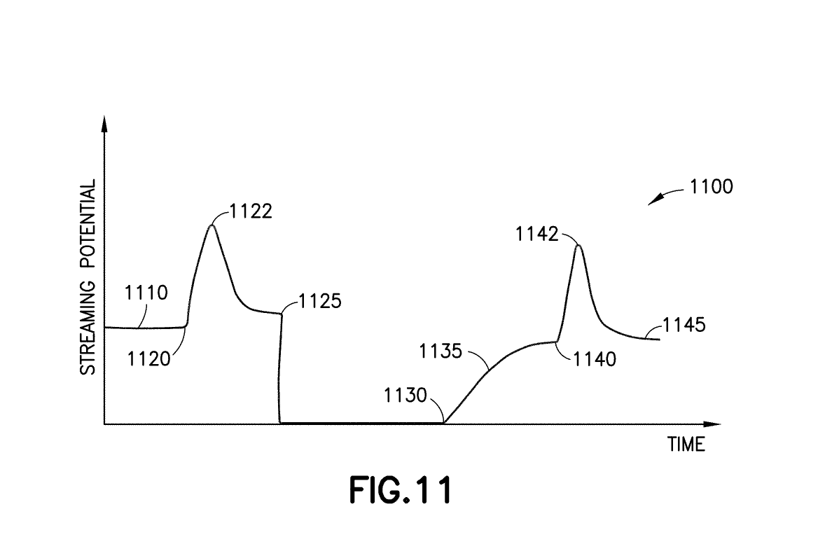

FIG. 11 is an example scenario of streaming potential measurements that are carried out by one or more downhole electrodes during a matrix acidizing operation. Trace 1100 shows the streaming potential response while an acid stimulation operation is progressing. The initial fluid, before perturbation, provides a background streaming potential 1110. At point 1120, a pad of detection fluid reaches the formation and causes the streaming potential response to increase and reach a peak 1122. As the pad disperses into the formation, there is a decrease in streaming potential to 1125. At this point the acid is injected which short circuits the streaming potential to zero for a period extending to 1330 when the acid injection end's and a post injection fluid is introduced. The newly injected fluid, which is not so conductive, causes the streaming potential to build up to a level 1135. At a point 1140 a pad of detection fluid reaches the formation causing the streaming potential to increase to 1142. As the volume of detection fluid in the vicinity of an electrode wears off, the streaming potential reduces to a level 1145. The levels 1110, 1125, 1135, and 1145 are not necessarily the same since at each stage either the formation or the fluid properties have been perturbed. Similarly, levels 1110 and 1135 are not necessarily the same as added wormholes have modified the formation permeability. Likewise, in general 1122 and 1142 are different.

As before, the trace in FIG. 11, includes a wealth of information on pre-stimulation phase, up to 1125, and post stimulation, past 1140. This trace can be modeled and inverted to determine the extent of wormholes created in the formation and their effect on formation permeability.

### Well Clean Up

Formation damage is one of the major factors limiting actual well productivity. This is especially true for long, horizontal wells that have been drilled and completed with water-based fluids. The subset of mud particles that are extremely fine pass into the formation pore space during the invasion phase and generally tend to reduce the permeability of formation adjacent to the wellbore. This low permeability skin acts as a permeability barrier, interfering with the flow of formation fluid into the borehole during production. The particle invasion is usually remedied using an acid capable of dissolving the fines. Streaming potential can help answer questions about when the acid bypasses the damaged zone, for example. As with the acid stimulation case shown in FIG. 11, injection of the highly conductive acid is accompanied by low or no streaming potential, but the pre-treatment and post-treatment phases can be studied using streaming potential measurements. The general time dependent streaming potential behavior for the well bore cleanup is similar to FIG. 11.

In mutual solvent well cleanup operations, mutual solvent is injected into the damaged zone of the formation near the wellbore where the solvent dissolves organic deposits near the wellbore to improve permeability in the formation adjacent to the wellbore. As a result of the extreme contrast of conductivity between the mutual solvent and formation water, streaming potential can be an effective method of monitoring the progress.

Monitoring well cleanup adds additional value by providing more effective cleanup. Real-time, downhole streaming potential data can be used to ensure that the cleanup propagation depth is passed through the damage zone and the data can be used to optimize the cleanup operation.

In the example cases described above, the detection fluid is designed to enhance the measured formation potential. The measured response carries additional information since at least one of the parameters has changed. In some cases, the streaming potential may already be high, and it would not be possible to enhance the measurement significantly. In such cases, it is possible to design the detection fluid to cause the streaming potential decrease to a level which is still measurable.

The streaming potential data of FIGS. 9A, 9B, 10A, 10B and 11 can be modeled using forward models, such as the one described in U.S. Pat. No. 7,520,234, the contents of which is herein incorporated by reference. Formation parameters, such as fluid permeability and fluid conductivity, composition, viscosity, and pressure, are used as input to the forward model. Inversion models iteratively apply the forward model while varying the formation properties. The inversion model provides quantitative values for formation properties and helps gain insight about the formation and production, stimulation, and borehole clean-up operations.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A downhole electrode assembly for deployment in a wellbore that traverses a rock formation, wherein the wellbore is filled with a wellbore fluid, the assembly comprising:
an electrode for contacting the rock formation;
a pliable structure that is configured during operation to contact the rock formation and provide a fluid barrier that isolates the electrode from the wellbore fluid; and
a force member configured to apply a force that presses the assembly against the rock formation.

2. The downhole electrode assembly of claim 1, further comprising:
a carrier that interfaces to the force member;
a layer made from an electrically-insulating material and disposed between the electrode and the carrier; and
a connector for electrical connection to a cable.

3. The downhole electrode assembly of claim 1, wherein:
the pliable structure is configured to extrude away from the assembly toward the rock formation and contact the rock formation and form the fluid barrier that isolates the electrode from the wellbore fluid in response to the force applied by the force member.

4. The downhole electrode assembly of claim 1, wherein:
the pliable structure surrounds the electrode;
the fluid barrier provided by the pliable structure surrounds the electrode; and
the pliable structure comprises a soft polymeric material.

5. The downhole electrode assembly of claim 1, wherein:
the electrode includes a plurality of raised elements that are configured to contact the rock formation.

6. The downhole electrode assembly of claim 5, wherein:
the plurality of raised elements operates as stress concentrators.

7. A method of measuring a voltage in a wellbore that traverses a rock formation, wherein the wellbore is filled with a wellbore fluid, the method comprising:
providing at least one downhole electrode assembly of claim 1;
conveying the at least one downhole electrode assembly to a desired location in the wellbore;
activating the force member of the at least one downhole electrode assembly such that the electrode is in contact with the rock formation and the pliable structure provides the fluid barrier that isolates the electrode from the wellbore fluid; and
configuring an acquisition unit to perform a voltage measurement using the electrode of the at least one downhole electrode assembly with the electrode in contact with the rock formation.

8. The method of claim 7, wherein:
the activating involves a mode selected from a surface activated control mode, a passive hydraulic control mode, and a corrosion activated mode.

9. The method of claim 7, further comprising:
configuring a telemetry module to communicate the voltage measurement to an uphole location.

10. The method of claim 7, wherein:
the voltage measurement is performed in conjunction with movement of conductive fluid in the rock formation over time to infer at least one property of the rock formation over time.

11. The method of claim 10, wherein:
the movement of fluid in the rock formation is part of a production operation.

12. The method of claim 7, wherein:
the voltage measurement is a measure of streaming potential.

13. A method for characterizing a rock formation that is traversed by a wellbore, the method comprising:
deploying at least one downhole electrode in contact with the rock formation at a desired location in the wellbore, wherein the at least one downhole electrode is operably coupled to an acquisition unit;
injecting a first fluid into the rock formation;
using the downhole electrode and acquisition unit to measure and record a first potential signal in response to flow of the first fluid in the rock formation;
injecting a pad of a second fluid into the rock formation, wherein the second fluid is different from the first fluid;
using the downhole electrode and acquisition unit to measure and record a second potential signal in response to flow of the pad of a second fluid in the rock formation; and
inferring a property of the rock formation using the first potential and the second potential.

14. The method of claim 13, wherein:
the property of the rock formation comprises permeability of the rock formation.

15. The method of claim 13, wherein:
the property of the rock formation comprises heterogeneity of the rock formation.

16. The method of claim 13, wherein:
the second fluid has different conductivity, viscosity, composition, or pressure compared to the first fluid.

17. The method of claim 13, wherein:
multiple pads of the second fluid are injected into the formation;
the downhole electrode and acquisition unit are used to measure and record potential signals in response to flow of the multiple pads of the second fluid; and
such potential signals are used to infer the property of the rock formation.

18. The method of claim 13, wherein:
the pad of the second fluid is injected into the rock formation before or after injection of the first fluid into the rock formation

19. The method of claim 13, wherein:
the first potential measurement and the second potential measurement are measures of streaming potential.

20. The method of claim 13, wherein:
the at least one downhole electrode is deployed in contact with the rock formation with a fluid barrier that isolates the electrode from wellbore fluid.
